(19) United States
(12) Patent Application Publication
(10) Pub. No.: US 2007/0227966 A1
(43) Pub. Date: Oct. 4, 2007

(54) Composite polyamide reverse osmosis membrane showing high boron rejection and method of producing the same

(76) Inventors: Ja-young Koo, Billerica, MA (US); Sung Pyo Hong, Gumi City (KR)

Correspondence Address: KRIEGSMAN & KRIEGSMAN, 30 TURNPIKE ROAD, SUITE 9, SOUTHBOROUGH, MA, 01772, US

(21) Appl. No.: 11/395,620

(22) Filed: Mar. 31, 2006

(51) Int. Cl. B01D 29/00; B29C 65/00

(52) U.S. Cl. 210/490; 210/500.38; 264/41; 264/45.1

(57) ABSTRACT

A composite polyamide reverse osmosis membrane. The membrane includes a microporous support and a polyamide layer disposed over the microporous support, the polyamide layer including iodine atoms covalently bonded thereto. The membrane is preferably prepared by a process that includes the steps of providing a microporous support, forming a polyamide layer over the microporous support, and treating the polyamide layer with an aqueous solution comprising a compound, the compound comprising at least one iodine atom. Examples of the compound comprising at least one iodine atom include molecular iodine, iodine monobromide, iodine monochloride and iodine trichloride. The iodine-containing compound may be added to an aqueous solution and dissolved therein or may be formed in situ in the aqueous solution, for example, by adding to the aqueous solution an iodide salt and an oxidizing agent.

### BACKGROUND OF THE INVENTION

The present invention relates generally to reverse osmosis membranes and more particularly to a novel composite polyamide reverse osmosis membrane and to a method of producing the same.

It is known that dissolved substances can be separated from their solvents by the use of various types of selective membranes, such selective membranes including—listed in order of increasing pore size—reverse osmosis membranes, ultrafiltration membranes and microfiltration membranes. One use to which reverse osmosis membranes have previously been put is in the desalination of brackish water or seawater to provide large volumes of relatively non-salty water suitable for industrial, agricultural or home use. What is involved in the desalination of brackish water or seawater using reverse osmosis membranes is literally a filtering out of salts and other dissolved ions or molecules from the salty water by forcing the salty water through a reverse osmosis membrane whereby purified water passes through the membrane while salts and other dissolved ions and molecules do not pass through the membrane. Osmotic pressure works against the reverse osmosis process, and the more concentrated the feed water, the greater the osmotic pressure which must be overcome.

A reverse osmosis membrane, in order to be commercially useful in desalinating brackish water or seawater on a large scale, must possess certain properties. One such property is that the membrane have a high salt rejection coefficient. In fact, for the desalinated water to be suitable for many commercial applications, the reverse osmosis membrane should have a salt rejection capability of at least about 97%. Another important property of a reverse osmosis membrane is that the membrane possess a high flux characteristic, i.e., the ability to pass a relatively large amount of water through the membrane at relatively low pressures. Typically, the flux for the membrane should be greater than 10 gallons/ft²-day (gfd) at a pressure of 800 psi for seawater and should be greater than 15 gfd at a pressure of 220 psi for brackish water. For certain applications, a rejection rate that is less than that which would otherwise be desirable may be acceptable in exchange for higher flux and vice versa.

One common type of reverse osmosis membrane is a composite membrane comprising a microporous support and a thin polyamide film formed on the microporous support. Typically, the polyamide film is formed by an interfacial polymerization of a polyfunctional amine and a polyfunctional acyl halide.

An example of the aforementioned composite polyamide reverse osmosis membrane is disclosed in U.S. Pat. No. 4,277,344, inventor Cadotte, which issued Jul. 7, 1981, and which is incorporated herein by reference. The aforementioned patent describes an aromatic polyamide film which is the interfacial reaction product of an aromatic polyamine having at least two primary amines substituents with an aromatic acyl halide having at least three acyl halide substituents. In the preferred embodiment, a porous polysulfone support is coated with m-phenylenediamine in water. After removal of excess m-phenylenediamine solution from the coated support, the coated support is covered with a solution of trimesoyl chloride dissolved in “FREON” TF solvent (trichlorotrifluoroethane). The contact time for the interfacial reaction is 10 seconds, and the reaction is substantially complete in 1 second. The resulting polysulfone/polyamide composite is then air-dried.

Although the Cadotte membrane described above exhibits good flux and good salt rejection, various approaches have been taken to further improve the flux and salt rejection of composite polyamide reverse osmosis membranes. In addition, other approaches have been taken to improve the resistance of said membranes to chemical degradation and the like. Many of these approaches have involved the use of various types of additives to the solutions used in the interfacial polycondensation reaction.

For example, in U.S. Pat. No.4,872,984, inventor Tomaschke, which issued Oct. 10, 1989, and which is incorporated herein by reference, there is disclosed an aromatic polyamide membrane formed by (a) coating a microporous support with an aqueous solution comprising (i) an essentially monomeric, aromatic, polyamine reactant having at least two amine functional groups and (ii) a monofunctional, monomeric (i.e., polymerizable) amine salt to form a liquid layer on the microporous support, (b) contacting the liquid layer with an organic solvent solution of an essentially monomeric, aromatic, amine-reactive reactant comprising a polyfunctional acyl halide or mixture thereof, wherein the amine-reactive reactant has, on the average, at least about 2.2 acyl halide groups per reactant molecule, and (c) drying the product of step (b), generally in an oven at about 60° C. to 110° C. for about 1 to 10 minutes, so as to form a water permeable membrane.

Other patents disclosing the use of additives in the solutions employed in the interfacial polycondensation reaction include: U.S. Pat. No.4,983,291, inventors Chau et al., which issued Jan. 8, 1991; U.S. Pat. No. 5,576,057, inventors Hirose et al., which issued Nov. 19, 1996; U.S. Pat. No.5,614,099, inventors Hirose et al., which issued Mar. 25, 1997; U.S. Pat. No.4,950,404, inventor Chau, which issued Aug. 21, 1990; U.S. Pat. No.4,830,885, inventors Tran et al., which issued May 16, 1989; U.S. Pat. No. 6,245,234, inventors Koo et al., which issued Jun. 12,2001; U.S. Pat. No. 6,063,278, inventors Koo et al., which issued May 16, 2000; and U.S. Pat. No. 6,015,495, inventors Koo et al., which issued Jan. 18, 2000, all of which are incorporated herein by reference.

Another approach which has been taken to improve the performance of a composite polyamide reverse osmosis membrane is disclosed in U.S. Pat. No. 5,178,766, inventors Ikeda et al., which issued Jan. 12, 1993, and which is incorporated herein by reference. According to Ikeda et al., the salt rejection rate of a composite polyamide reverse osmosis membrane is said to be improved by covalently bonding to the polyamide film of said membrane a compound having a quaternary nitrogen atom. Said quaternary nitrogen atom-containing compound is bonded to the polyamide film through a reactive group present in the compound, said reactive group being an epoxy group, an aziridine group, an episulfide group, a halogenated alkyl group, an amino group, a carboxylic group, a halogenated carbonyl group, or a hydroxy group.

While the membranes described above are suitable for certain applications, such membranes typically do not possess a sufficiently high rejection coefficient for certain substances, such as boron (typically present as boric acid), that are not dissociated within the pH range representing normal usage of the membranes (pH 7 to 8). Boric acid is present in seawater at a concentration of approximately 5 ppm. It has been reported that the repeated intake of water containing boric acid at a concentration in excess of 0.5 ppm (mg/l) could cause health problems.

In U.S. Pat. No. 6,709,590, inventor Hirose, which issued Mar. 23, 2004, and which is incorporated herein by reference, there is disclosed a composite reverse osmosis membrane that is said to be capable of separating nonelectrolyte organic compounds such as isopropyl alcohol and general pH range nondissociative substances such as boron with high rejections. Said membrane is said to be prepared by forming a polyamide skin layer on a porous support, the polyamide skin layer being formed by reacting an aromatic compound having at least two reactive amino groups with a polyfunctional acid halide compound having at least two reactive acid halide groups. Then, the polyamide skin layer is treated with a free chlorine aqueous solution containing a bromine salt whereby a bromine atom is incorporated into the polyamide skin layer. The patent also teaches that, when the polyamide skin layer was treated with a free chlorine aqueous solution in the absence of the bromine salt, no significant improvement in rejection was obtained.

### SUMMARY OF THE INVENTION

It is an object of the present invention to provide a novel composite polyamide reverse osmosis membrane.

It is another object of the present invention to provide a composite polyamide reverse osmosis membrane that has a high rejection coefficient for substances like boric acid that are not dissociated within the pH range at which these membranes are normally used.

The present invention is premised on the unexpected discovery that the rejection of a composite polyamide reverse osmosis membrane to general pH range nondissociative substances like boric acid can be significantly improved by covalently bonding iodine atoms to the polyamide layer of said membrane.

Accordingly, the present invention is directed at a composite polyamide reverse osmosis membrane, said composite polyamide reverse osmosis membrane comprising:
(a) a microporous support; and
(b) a polyamide layer disposed over said microporous support, said polyamide layer including iodine atoms covalently bonded thereto.

According to another aspect, the present invention is directed at a composite polyamide reverse osmosis membrane, said composite polyamide reverse osmosis membrane being prepared by a process comprising:
(a) providing a microporous support;
(b) forming a polyamide layer over said microporous support; and
(c) treating said polyamide layer with a quantity of a compound comprising at least one iodine atom, whereby iodine atoms covalently bond to said polyamide layer.

For purposes of the present specification and claims, the term “iodine atom” is intended to mean a non-electrolytic iodine atom. As such, the term “iodine atom” specifically excludes an iodide anion.

The present invention is also directed to a method of producing a composite polyamide reverse osmosis membrane, said method comprising the steps of:
(a) providing a microporous support;
(b) forming a polyamide layer over said microporous support; and
(c) treating said polyamide layer with a quantity of a compound comprising at least one iodine atom, whereby iodine atoms covalently bond to said polyamide layer.

Additional objects, features, aspects and advantages of the present invention will be set forth, in part, in the description which follows and, in part, will be obvious from the description or may be learned by practice of the invention. Certain embodiments of the invention will be described hereafter in sufficient detail to enable those skilled in the art to practice the invention, and it is to be understood that other embodiments may be utilized and that structural or other changes may be made without departing from the scope of the invention. The following detailed description is, therefore, not to be taken in a limiting sense, and the scope of the present invention is best defined by the appended claims.

### DETAILED DESCRIPTION OF PREFERRED EMBODIMENTS

As noted above, the present invention is based on the unexpected discovery that the rejection coefficient of a composite polyamide reverse osmosis membrane for boric acid and other general pH range nondissociative substances can be significantly improved by covalently incorporating iodine atoms into the polyamide layer of the membrane.

The composite polyamide reverse osmosis membrane whose polyamide layer may be modified to include iodine atoms may be virtually any composite polyamide reverse osmosis membrane of the type comprising a porous support and a polyamide film disposed on said porous support.

The aforementioned porous support is typically a microporous support. The particular microporous support employed is not critical to the present invention but is generally a polymeric material containing pore sizes which are of sufficient size to permit the passage of permeate therethrough but not large enough so as to interfere with the bridging over of the ultrathin membrane formed thereon. The pore size of the support will generally range from 1 to 500 nanometers inasmuch as pores which are larger in diameter than 500 nanometers will permit the ultrathin film to sag into the pores, thus disrupting the flat sheet configuration desired. Examples of microporous supports useful in the present invention include those made of a polysulfone, a polyether sulfone, a polyimide, poly(methyl methacrylate), polyethylene, polypropylene and various halogenated polymers, such as polyvinylidene fluoride. Additional microporous support materials may be found in the patents incorporated herein by reference.

The thickness of the microporous support is not critical to the present invention. Generally, the thickness of the microporous support is about 25 to 125 μm, preferably about 40 to 75 μm.

The polyamide film of the present invention is typically the interfacial reaction product of a polyfunctional amine reactant and a polyfunctional amine-reactive reactant. The polyfunctional amine reactant employed in the present invention is preferably an essentially monomeric amine having at least two amine functional groups, more preferably 2 to 3 amine functional groups. The amine functional group is typically a primary or secondary amine functional group, preferably a primary amine functional group. The particular polyamine employed in the present invention is not critical thereto and may be a single polyamine or a combination thereof. Examples of suitable polyamines include aromatic primary diamines, such as meta-phenylenediamine and para-phenylenediamine and substituted derivatives thereof, wherein the substituent includes, e.g., an alkyl group, such as a methyl group or an ethyl group, an alkoxy group, such as a methoxy group or an ethoxy group, a hydroxy alkyl group, a hydroxyl group or a halogen atom. Additional examples of suitable polyamines include alkanediamines, such as 1,3-propanediamine and its homologs with or without N-alkyl or aryl substituents, cycloaliphatic primary diamines, cycloaliphatic secondary diamines, such as piperazine and its alkyl derivatives, aromatic secondary amines, such as N,N-dimethyl-1,3-phenylenediamine, N,N′-diphenylethylene diamine, benzidine, xylylene diamine and derivatives thereof. Other suitable polyamines may be found in the patents incorporated herein by reference. The preferred polyamines of the present invention are aromatic primary diamines, more preferably m-phenylenediamines.

The polyfunctional amine reactant is typically present in an aqueous solution in an amount in the range of from about 0.1 to 20%, preferably 0.5 to 8%, by weight, of the aqueous solution. The pH of the aqueous solution is in the range of from about 7 to 13. The pH can be adjusted by the addition of a basic acid acceptor in an amount ranging from about 0.001% to about 5%, by weight, of the solution. Examples of the aforementioned basic acid acceptor include hydroxides, carboxylates, carbonates, borates, phosphates of alkali metals, and trialkylamines.

In addition to the aforementioned polyfunctional amine reactant (and, if desired, the aforementioned basic acid acceptor), the aqueous solution may further comprise additives of the type described in the patents incorporated herein by reference, such additives including, for example, polar solvents, amine salts and polyfunctional tertiary amines (either in the presence or absence of a strong acid).

The polyfunctional amine-reactive reactant employed in the present invention is one or more compounds selected from the group consisting of a polyfunctional acyl halide, a polyfunctional sulfonyl halide and a polyfunctional isocyanate. Preferably, the polyfunctional amine-reactive reactant is an essentially monomeric, aromatic, polyfunctional acyl halide, examples of which include di- or tricarboxylic acid halides, such as trimesoyl chloride (TMC), isophthaloyl chloride (IPC), terephthaloyl chloride (TPC) and mixtures thereof. Examples of other polyfunctional amine-reactive reactants are disclosed in the patents incorporated herein by reference.

The polyfunctional amine-reactive reactant is typically present in an organic solvent solution, the solvent for said organic solvent solution comprising any organic liquid immiscible with water. The polyfunctional amine-reactive reactant is typically present in the organic liquid in an amount in the range of from about 0.005 to 5 wt % preferably 0.01 to 0.5 wt % of the solution. Examples of the aforementioned organic liquid include hexane, cyclohexane, heptane, alkanes having from 8 to 12 carbon atoms, and halogenated hydrocarbons, such as the FREON series. Other examples of the above-described organic liquid may be found in the patents incorporated herein by reference. Preferred organic solvents are alkanes having from 8 to 12 carbon atoms and mixtures thereof. ISOPAR® solvent (Exxon Corp.) is such a mixture of alkanes having from 8 to 12 carbon atoms.

In accordance with the teachings of the present invention, the polyamide layer of the membrane is modified by the covalent bonding of iodine atoms thereto. This modification is effected by treating the polyamide layer with a compound that comprises at least one iodine atom. Examples of compounds that comprise at least one iodine atom include, but are not limited to, molecular iodine (I₂), iodine monobromide (IBr), iodine monochloride (ICl), iodine trichloride (ICl₃), and complexes of molecular iodine and an iodide salt (e.g., KI₃). Preferably, the manner by which the polyamide membrane is treated with the compound comprising at least one iodine atom is by providing an aqueous solution in which the compound is dissolved and then by contacting the membrane with the aqueous solution.

The above-described compound comprising at least one iodine atom is typically present in the aqueous solution used to contact the polyamide membrane in an amount ranging from about 0.1 to 500 ppm (ppm means part per million and corresponds to mg per liter), preferably 0.5 to 100 ppm of the aqueous solution.

Many of the above-identified compounds comprising at least one iodine atom, such as molecular iodine, iodine monobromide, iodine monochloride and iodine trichloride, are available commercially or can be easily made in a laboratory. Accordingly, an aqueous solution comprising such a compound may be made simply by dissolving the previously-prepared compound in water. However, whereas some compounds like iodine trichloride dissolve rather easily in water, other compounds like molecular iodine, iodine monochloride and iodine monobromide are only slightly soluble in water. Consequently, it may take several hours to dissolve these compounds in water to achieve a concentration of 5 ppm. In order to improve the dissolution of these compounds in water, one may dissolve the compound in a water-soluble organic solvent and then mix this solution with water to yield an aqueous solution containing the compound. In this manner, an aqueous solution containing the compound can be achieved in less than twenty minutes. Examples of suitable water-soluble organic solvents that may be used for this purpose include, but are not limited to, alcohols, such as ethanol and isopropyl alcohol; ethers, such as methoxyethyl ether, ethylene glycol dimethyl ether, and tetrahydrofuran; sulfoxides, such as dimethyl sulfoxide and tetramethylene sulfoxide; sulfones, such as dimethyl sulfone, ethyl sulfone and tetramethylene sulfone; amides, such as N,N-dimethyl acetamide, N,N-dimethyl formamide, N-methyl acetamide, N-methyl propionamide and N-methyl pyrrolidinone; esters, such as ethyl acetate and methyl propionate; and nitrites, such as acetonitrile and propionitrile. For example, 0.3 g iodine monobromide may be dissolved in 5 g methoxyethyl ether, with the resulting solution poured to 30 l water to give an aqueous solution of 5 ppm iodine monobromide.

Alternatively, instead of dissolving the previously-prepared compound in water (with or without the use of a water-soluble organic solvent), many of these compounds may be formed in situ in an aqueous solution by adding an oxidizing agent and an iodide salt to the aqueous solution. Examples of a suitable oxidizing agent include, but are not limited to, molecular chlorine, sodium hypochlorite, sodium chlorite, sodium chlorate, sodium perchlorate, molecular bromine, sodium bromate, potassium iodate, potassium periodate, sodium persulfate, sodium permanganate, sodium chromate, sodium percabonate, sodium perborate, hydrogen peroxide and its derivatives, such as peracetic acid and perbenzoic acid. Examples of a suitable iodide salt include all water-soluble iodide compounds, such as, but not being limited to, sodium iodide, potassium iodide, lithium iodide, hydrogen iodide, ammonium iodide, cesium iodide, magnesium iodide, and calcium iodide.

For example, molecular iodine may be produced by reacting in water an iodide salt, such as sodium iodide or potassium iodide, with an oxidizing compound, such as molecular chlorine, sodium hypochlorite, sodium chlorite, sodium chlorate, sodium perchlorate, molecular bromine, sodium bromate, potassium iodate, potassium periodate, sodium persulfate, sodium permanganate, sodium chromate, sodium percarbonate, sodium perborate, hydrogen peroxide and its derivatives, such as peracetic acid and perbenzoic acid. Iodine bromides, such as iodine monobromide, may be obtained in situ by reacting molecular iodine with molecular bromine in specific ratios. Iodine chlorides, such as iodine monochloride and iodine trichloride, may be obtained in situ by reacting molecular iodine with molecular chlorine in specific ratios.

In accordance with the teachings of the present invention, a composite polyamide reverse osmosis membrane having a high rejection coefficient for boric acid and other general pH range nondissociative substances may be made as follows: First, the above-described porous support is coated with the above-described aqueous solution utilizing either a hand coating or a continuous operation, and the excess solution is removed from the support by rolling, sponging, air knifing or other suitable techniques. Following this, the coated support material is then contacted, for example, by dipping or spraying, with the above-described organic solvent solution and allowed to remain in place for a period of time in the range of from about 5 seconds to about 10 minutes, preferably about 20 seconds to 4 minutes. The resulting product is then dried at a temperature below 50° C., preferably by air-drying at room temperature, for about 1 minute, then rinsed in a basic aqueous solution, such as 0.2% sodium carbonate, for a period of time in the range of from about 1 minute to 30 minutes at a temperature in the range from about room temperature to 95° C., and then rinsed with deionized water.

The polyamide membrane is then contacted, by dipping or spraying, with an aqueous solution of a compound comprising at least one iodine atom at a temperature ranging from about room temperature to 95° C. for a period of about 1 minute to 10 hours at a pH ranging from about 2 to 11, preferably about 3 to 10. Alternatively, the membrane maybe contacted in vapor phase with said iodine atom-containing compound, which compound can be vaporized at a temperature ranging from about room temperature to 95° C. Alternatively, the polyamide membrane may also be treated in a pressurized system with an aqueous solution of said compound by passing the solution through the membrane in a crossflow mode at a pressure of about 50 psi to 800 psi and a temperature ranging from about 20° C. to 40° C. for a period of about 1 minute to 1 hour at a pH ranging from about 2 to 11, preferably about 3 to 10.

The presence of iodine in the polyamide layer of the membrane after the aforementioned treatment was confirmed by electron spectroscopy for chemical analysis (ESCA). A polyamide membrane having more than 0.05% atomic concentration of iodine measured by ESCA showed higher boron rejection than an untreated control membrane.

The following examples are provided for illustrative purposes only and are in no way intended to limit the scope of the present invention:

### EXAMPLE 1

A 140 μm thick microporous polysulfone support including the backing non-woven fabric was soaked in an aqueous solution containing 3 wt % of meta-phenylenediamine (MPD) and 0.05 wt % 2-ethyl-1,3-hexanediol for 40 seconds. The support was drained and nip rolled to remove the excess aqueous solution. Then, the coated support was dipped in a solution of 0.1 wt % trimesoyl chloride (TMC) and 0.14 wt % isophthaloyl chloride (IPC) in Isopar® solvent (Exxon Corp.) for 1 minute followed by draining the excess organic solution off the support. The resulting composite membrane was air-dried for about 1 minute and then rinsed in 0.2% Na₂CO₃ aqueous solution for 30 minutes at room temperature, and then rinsed in deionized water.

The initial performance of the membrane was measured by passing an aqueous solution containing 32000 ppm of NaCl and 5 ppm boron (in the form of boric acid) through the membrane in a crossflow mode at 800 psi and 25° C. at a pH of 8. The salt rejection and the boron rejection were 99.5% and 86%, respectively, and the flux was 18 gfd. The membrane was then further treated with an aqueous solution of 100 ppm sodium hypochlorite (NaOCl) and 20 ppm potassium iodide (KI) at pH 5 by passing the iodine solution through the membrane in a crossflow mode at 225 psi and 25° C. for 30 minutes. After the iodine solution treatment, the salt rejection and the boron rejection were tested under the same conditions described above and were found to be 99.7% and 95%, respectively. The flux was also tested under the same conditions above and was found to be 15.2 gfd. Table 1 presents the data described above.

### COMPARATIVE EXAMPLE 1

The same procedure as set forth in Example 1 was carried out for Comparative Example 1, except that the membrane was not further treated with an aqueous solution containing an iodine compound. The salt rejection, the boron rejection, and the flux were 99.5%, 86% and 18 gfd, respectively, as noted below in Table I.

### COMPARATIVE EXAMPLE 2

The same procedure as set forth in Example 1 was carried out for Comparative Example 2, except that, instead of treating the membrane with an aqueous solution containing an iodine compound, the membrane was treated with an aqueous solution of 100 ppm sodium hypochlorite (NaOCl) and 10 ppm sodium bromide (NaBr) at pH 5. The salt rejection, the boron rejection, and the flux were 99.7%, 93.6% and 11.8 gfd, respectively, as noted below in Table I.

### EXAMPLE 2

The same procedure as set forth in Example 1 was carried out for Example 2, except that, instead of treating the membrane with an aqueous solution containing sodium hypochlorite (NaOCl) and potassium iodide (KI) (presumably to yield in situ molecular iodine), the membrane was treated with an aqueous solution at pH 9 of 5 ppm molecular iodine (I₂). The salt rejection, the boron rejection, and the flux were 99.7%, 94.1% and 14.1 gfd, respectively, as noted below in Table I.

### EXAMPLE 3

The same procedure as set forth in Example 1 was carried out for Example 3, except that, instead of treating the membrane with an aqueous solution containing sodium hypochlorite (NaOCl) and potassium iodide (KI) (presumably to yield in situ molecular iodine), the membrane was treated with an aqueous solution at pH 9 of 5 ppm iodine bromide (IBr). The salt rejection, the boron rejection, and the flux were 99.7%, 95.0% and 14.0 gfd, respectively, as noted below in Table I.

### EXAMPLE 4

The same procedure as set forth in Example 1 was carried out for Example 4, except that, instead of treating the membrane with an aqueous solution containing sodium hypochlorite (NaOCl) and potassium iodide (KI) (presumably to yield in situ molecular iodine), the membrane was treated with an aqueous solution at pH 9 of 5 ppm iodine chloride (ICl). The salt rejection, the boron rejection, and the flux were 99.6%, 94.6% and 11.9 gfd, respectively, as noted below in Table I.

### EXAMPLE 5

The same procedure as set forth in Example 1 was carried out for Example 5, except that, instead of treating the membrane with an aqueous solution containing sodium hypochlorite (NaOCl) and potassium iodide (KI) (presumably to yield in situ molecular iodine), the membrane was treated with an aqueous solution at pH 5.5 of 3 ppm molecular iodine (I₂). The salt rejection, the boron rejection, and the flux were 99.7%, 93.9% and 11.8 gfd, respectively, as-noted below in Table I.

### EXAMPLE 6

The same procedure as set forth in Example 1 was carried out for Example 6, except that, instead of treating the membrane with an aqueous solution containing sodium hypochlorite (NaOCl) and potassium iodide (KI) (presumably to yield in situ molecular iodine), the membrane was treated with an aqueous solution at pH 5.5 of 3 ppm iodine bromide (IBr). The salt rejection, the boron rejection, and the flux were 99.8%, 95.6% and 9.8 gfd, respectively, as noted below in Table I.

### EXAMPLE 7

The same procedure as set forth in Example 1 was carried out for Example 7, except that, instead of treating the membrane with an aqueous solution containing sodium hypochlorite (NaOCl) and potassium iodide (KI) (presumably to yield in situ molecular iodine), the membrane was treated with an aqueous solution at pH 5.5 of 3 ppm iodine chloride (ICl). The salt rejection, the boron rejection, and the flux were 99.6%, 97.0% and 9.7 gfd, respectively, as noted below in Table I.

### EXAMPLE 8

The same procedure as set forth in Example 1 was carried out for Example 8, except that, instead of treating the membrane with an aqueous solution containing sodium hypochlorite (NaOCl) and potassium iodide (KI) (presumably to yield in situ molecular iodine), the membrane was treated with an aqueous solution at pH 3.9 of 5 ppm iodine trichloride (,1C₃). The salt rejection, the boron rejection, and the flux were 99.7%, 95.0% and 8.9 gfd, respectively, as noted below in Table I.

### EXAMPLE 9

The same procedure as set forth in Example 1 was carried out for Example 9, except that, instead of treating the membrane with an aqueous solution containing sodium hypochlorite (NaOCl) and potassium iodide (KI) (presumably to yield in situ molecular iodine), the membrane was treated with an aqueous solution at pH 3 of 100 ppm peracetic acid and 20 ppm potassium iodide (KI) (presumably to yield in situ molecular iodine). The salt rejection, the boron rejection, and the flux were 99.7%, 95.5% and 9.1 gfd, respectively, as noted below in Table I.

### EXAMPLE 10

The same procedure as set forth in Example 1 was carried out for Example 10, except that, instead of treating the membrane with an aqueous solution containing sodium hypochlorite (NaOCl) and potassium iodide (KI) (presumably to yield in situ molecular iodine), the membrane was treated with an aqueous solution of 5 ppm potassium periodate (KIO₄) and 18 ppm potassium iodide (KI) (presumably to yield in situ molecular iodine). The salt rejection, the boron rejection, and the flux were 99.7%, 94.0% and 11.5 gfd, respectively, as noted below in Table I.

### EXAMPLE 11

The same procedure as set forth in Example 1 was carried out for Example 11, except that, instead of treating the membrane with an aqueous solution containing sodium hypochlorite (NaOCl) and potassium iodide (KI) (presumably to yield in situ molecular iodine), the membrane was treated with an aqueous solution of 20 ppm potassium iodide-iodine complex (KI₃) (presumably to yield in situ molecular iodine). The salt rejection, the boron rejection, and the flux were 99.6%, 93.6% and 13.3 gfd, respectively, as noted below in Table I.

TABLE I

| Membrane | Salt Rejection (%) | Boron Rejection (%) | Flux (gfd) |
|---|---|---|---|
| Comparative | 99.5 | 86.0 | 18.0 |
| Example 1 | | | |
| Comparative | 99.7 | 93.6 | 11.8 |
| Example 2 | | | |
| Example 1 | 99.7 | 95.0 | 15.2 |
| Example 2 | 99.7 | 94.1 | 14.1 |
| Example 3 | 99.7 | 95.0 | 14.0 |
| Example 4 | 99.6 | 94.6 | 11.9 |
| Example 5 | 99.7 | 93.9 | 11.8 |
| Example 6 | 99.8 | 95.6 | 9.8 |
| Example 7 | 99.6 | 97.0 | 9.7 |
| Example 8 | 99.7 | 95.0 | 8.9 |
| Example 9 | 99.7 | 95.5 | 9.1 |
| Example 10 | 99.7 | 94.0 | 11.5 |
| Example 11 | 99.6 | 93.6 | 13.3 |

As can be seen, the membranes treated with compounds comprising an iodine atom (Examples 1-11) exhibited a significantly higher boron rejection than did the untreated membrane (Comparative Example 1). In addition, the membranes of Examples 1-10 exhibited a higher boron rejection than did the membrane treated with bromine (Comparative Example 2), with the membranes of Examples 1-4 also exhibiting a higher flux than the bromine-treated membrane (Comparative Example 2) and the membranes of Examples 6-10 showing a significantly greater boron rejection than the bromine-treated membrane (Comparative Example 2). Moreover, the membrane of Example 11, while exhibiting a boron rejection comparable to that of the membrane treated with bromine (Comparative Example 2), exhibited a considerably greater flux.

The embodiments of the present invention recited herein are intended to be merely exemplary and those skilled in the art will be able to make numerous variations and modifications to it without departing from the spirit of the present invention. All such variations and modifications are intended to be within the scope of the present invention as defined by the claims appended hereto.

What is claimed is:

1. A composite polyamide reverse osmosis membrane, said composite polyamide reverse osmosis membrane comprising:
(a) a microporous support; and
(b) a polyamide layer disposed over said microporous support, said polyamide layer including iodine atoms covalently bonded thereto.

2. A composite polyamide reverse osmosis membrane, said composite polyamide reverse osmosis membrane being prepared by a process comprising:
(a) providing a microporous support;
(b) forming a polyamide layer over said microporous support; and
(c) treating said polyamide layer with a quantity of a compound, said compound comprising at least one iodine atom, whereby iodine atoms covalently bond to said polyamide layer.

3. The composite polyamide reverse osmosis membrane as claimed in claim 2 wherein said compound comprising at least one iodine atom is selected from the group consisting of molecular iodine, iodine monobromide, iodine monochloride, iodine trichloride, and potassium tri-iodide.

4. The composite polyamide reverse osmosis membrane as claimed in claim 2 wherein said treating step comprises providing an aqueous solution comprising said compound and then contacting said polyamide layer with said aqueous solution.

5. The composite polyamide reverse osmosis membrane as claimed in claim 4 wherein said aqueous solution is prepared by providing said compound and then dissolving said compound in an aqueous solvent.

6. The composite polyamide reverse osmosis membrane as claimed in claim 5 wherein said dissolving step comprises first dissolving said compound in a water-soluble organic solvent and then adding water to said water-soluble organic solvent into which said compound has been dissolved.

7. The composite polyamide reverse osmosis membrane as claimed in claim 4 wherein said aqueous solution is prepared by adding an iodide salt and an oxidizing agent to an aqueous solvent in order to generate said compound in situ.

8. The composite polyamide reverse osmosis membrane as claimed in claim 2 wherein said polyamide layer contains iodine atoms in a concentration of at-least 0.05% atomic concentration, as measured by electron spectroscopy for chemical analysis.

9. A method of preparing a composite polyamide reverse osmosis membrane, said method comprising the steps of:
(a) providing a microporous support;
(b) forming a polyamide layer over said microporous support; and
(c) treating said polyamide layer with a quantity of a compound, said compound comprising at least one iodine atom, whereby iodine atoms covalently bond to said polyamide layer.

10. The method as claimed in claim 9 wherein said compound comprising at least one iodine atom is selected from the group consisting of molecular iodine, iodine monobromide, iodine monochloride, iodine trichloride, and potassium tri-iodide.

11. The method as claimed in claim 10 wherein said compound is selected from the group consisting of iodine monobromide, iodine monochloride and iodine trichloride.

12. The method as claimed in claim 9 wherein said treating step comprises providing an aqueous solution comprising said compound and then contacting said polyamide layer with said aqueous solution.

13. The method as claimed in claim 12 wherein said aqueous solution is prepared by providing said compound and then dissolving said compound in an aqueous solvent.

14. The method as claimed in claim 13 wherein said dissolving step comprises first dissolving said compound in a water-soluble organic solvent and then adding water to said water-soluble organic solvent into which said compound has been dissolved.

15. The method as claimed in claim 14 wherein said water-soluble organic solvent is selected from the group consisting of alcohols, ethers, sulfoxides, sulfones, amides, esters, and nitriles.

16. The method as claimed in claim 15 wherein said water-soluble organic solvent is selected from the group consisting of ethanol, isopropyl alcohol, methoxyethyl ether, ethylene glycol dimethyl ether, tetrahydrofuran, dimethyl sulfoxide, tetramethylene sulfoxide, dimethyl sulfone, ethyl sulfone, tetramethylene sulfone, N,N-dimethyl acetamide, N,N-dimethyl formamide, N-methyl acetamide, N-methyl propionamide, N-methyl pyrrolidinone, ethyl acetate, methyl propionate, acetonitrile and propionitrile.

17. The method as claimed in claim 12 wherein said aqueous solution is prepared by adding an iodide salt and an oxidizing agent to an aqueous solvent in order to generate said compound in situ.

18. The method as claimed in claim 17 wherein said oxidizing agent is selected from the group consisting of molecular chlorine, sodium hypochlorite, sodium chlorite, sodium chlorate, sodium perchlorate, molecular bromine, sodium bromate, potassium iodate, potassium periodate, sodium persulfate, sodium permanganate, sodium chromate, sodium percabonate, sodium perborate, and hydrogen peroxide and its derivatives.

19. The method as claimed in claim 12 wherein said compound comprising at least one iodine atom is present in said aqueous solution in an amount ranging from about 0.1 to 500 ppm of said aqueous solution.

20. The method as claimed in claim 19 wherein said compound comprising at least one iodine atom is present in said aqueous solution in an amount ranging from about 0.5 to 100 ppm of said aqueous solution.

21. The method as claimed in claim 12 wherein said contacting step comprises dipping or spraying said polyamide layer with said aqueous solution at a temperature in the range of room temperature to 950 C for a period of about 1 minute to 10 hours at a pH ranging from about 2 to 11.

22. The method as claimed in claim 12 wherein said contacting step comprises passing said aqueous solution through the polyamide layer in a crossflow mode at a pressure of about 50 psi to 800 psi and at a temperature ranging from about 20° C. to 40° C. for a period of about 1 minute to 1 hour at a pH ranging from about 2 to 11.
